(19) United States
(12) Patent Application Publication
(10) Pub. No.: US 2008/0205048 A1
(43) Pub. Date: Aug. 28, 2008

(54) COLD WEATHER EQUIPMENT BOX

(76) Inventor: Aaron C. Andrews, Isanti, MN (US)

Correspondence Address: MOORE & HANSEN, PLLP, 225 SOUTH SIXTH ST, MINNEAPOLIS, MN, 55402, US

(21) Appl. No.: 11/679,555

(22) Filed: Feb. 27, 2007

(51) Int. Cl. A45C 15/06; F21V 29/00

(52) U.S. Cl. 362/156; 362/373

(57) ABSTRACT

An equipment box, particularly useful for ice fishing, capable of powering multiple electrical and electronic devices. The equipment box includes a heat generating light source and a housing having a top portion, a bottom portion and a battery enclosure within the bottom portion that accommodates a battery to power the light source. Otherwise wasted heat energy produced by the light source is directed to the battery via a heat channel to warm the battery, thus prolonging battery life and capacity in cold conditions. The enclosure may include a separate layer of insulation as well as a liner positioned between the insulation and the battery so that the battery can be easily removed from the enclosure. The equipment box preferably includes an accessory mount that allows a fish finder to moved between a storage position located within the housing and an operating position located outside the housing.

### BACKGROUND OF THE DISCLOSURE

1. Field of the Invention

The present invention relates generally to equipment boxes used for cold weather work or sport activity. Particularly, the present invention relates to equipment boxes for use in low light, frigid, ice fishing conditions, where reliable battery power is needed by a user for the operation of multiple electric devices such as light sources, mobile phone, a fish finder, radio and the like.

2. Description of the Related Art

Known fishing equipment boxes have a storage housing covered by a lid, the housing having various compartments and trays to store fishing gear such as line, hooks, lures and the like. It is now a common practice in ice fishing to use battery powered devices while fishing, for example, light sources due to shortened winter days and the preference for dawn or dusk fishing, mobile phones, radios and portable music devices for safety and enjoyment, and fish finders for ease of site location. All these devices require sources of battery power, and all such battery power sources experience diminished power capabilities when used outdoors under low temperature conditions.

In addition to the described electrical power difficulties, all the described electrical devices are somewhat fragile, and carrying them to the fishing site without damaging them presents a further challenge. Typically the fish finder must be carefully handled and protected from dropping and destructive impact or contact with other gear, and consequently the fish finder is usually carried to a fishing site in its own separate, protective container. Similarly, lighting devices, whether electric or gas powered, are somewhat fragile and require careful handling during transport to the ice fishing site. At times, a storage battery or propane canister must be carried to the site and also requires special care during transport. In addition, the fisherman often brings a chair, portable shelter and multiple transport containers to carry and protect some or all of the foregoing.

All of these described accessories, devices and containers are burdensome to transport since, as the name implies, ice fishing is done on a sheet of ice usually distant from the shore of a lake or river and far from the fisherman's vehicle. While various transport carts and containers have been developed for ice fishing use, there is no known single container or transport mechanism which allows multiple electrical and fishing accessories to be protectively housed and transported and a storage battery power source effectively protected from the frigid temperatures which can substantially diminish its electrical capacity.

U.S. Pat. No. 4,697,379 to McPhaul discloses a general purpose thin walled fishing tackle box with one or more flashlight bulbs and connects the bulbs to a flashlight battery stored in the tackle box. While the McPhaul device is an effective lighting device for warm season fishing, McPhaul discloses no features for addressing the more extreme cold temperature conditions of ice fishing or to protecting a battery from the cold. McPhaul simply assists a fisherman by avoiding the need for a separate flashlight.

The known equipment boxes are not well adapted for protecting a battery for prolonged use in the frigid conditions, such as those conditions associated with ice fishing. The known equipment boxes provide no adequate insulation mechanism to insulate a battery power source from the ambient cold and no mechanism to generate, capture, or apply heat to the battery power source. Consequently the battery used in a tackle box like that of McPhaul quickly cools to outdoor temperatures and the electrical output capacity of the battery diminishes significantly. As batteries cool down and eventually even freeze, they quickly reach a point where they cannot deliver enough power to keep up with the larger demand needed by the more numerous electrical devices now used. If the battery could be maintained at a warmer temperature, it would operate normally.

Therefore, an equipment box is needed that is capable of safely storing the multiple, sometimes fragile electrical devices now used in outdoor activities, such as ice fishing, and which is capable of sheltering an effective storage battery under frigid conditions for energizing those devices, that effectively insulates the battery from the cold and provides a mechanism for recovering otherwise wasted heat energy to warm the battery. The present invention addresses these needs.

### SUMMARY OF THE INVENTION

Generally, the present invention provides an equipment box with an interior battery enclosure, which stores a battery that selectively powers a heat generating light bulb and various other electric devices such as multiple energy efficient light sources, mobile phones, radios, battery charge level indicator and the like. The equipment box is arranged and configured to direct heat produced from the heat generating light bulb to the battery such that an efficient battery working temperature is maintained. When such battery temperature is maintained, the battery output capacity is also maintained, even in the frigid conditions associated with ice fishing. In preferred embodiments, the battery is positioned within an insulated battery enclosure to receive otherwise wasted heat from an adjacent light source and to retain such heat adjacent the battery for a time period adequate to meet the needs of a user.

The preferred equipment box of the present invention further includes an accessory mount for safely, conveniently moving a fish finder between a safe storage position within the box and an operating position external to the box. The accessory mount is preferably rotatably fastened to the tackle box, which is arranged and configured such that the fish finder may be positioned outside of the box in the operating position even when the box lid is closed. This provides numerous advantages as the fish finder may be used even while the box is being moved about, and since the box lid is closed, the battery will remain better insulated and protected from the elements during all such movement.

It is an object of the present invention to provide an equipment box that adequately powers and stores multiple battery operated devices. It is another object of the present invention to provide an equipment box that maintains battery energy capacity for a longer time intervals during frigid conditions, such as those associated with ice fishing. It is a further object of the present invention to provide an equipment box that uses otherwise wasted heat energy produced by a heat generating light bulb to maintain an effective working temperature for the battery.

### BRIEF DESCRIPTION OF THE DRAWINGS

FIG. 1 is a partial cutaway, perspective view of an embodiment of an equipment box of the present invention in which a top flap that normally overlies the battery has been removed for clarity;

FIG. 2 is a perspective view of the embodiment of FIG. 1 illustrating a fish finder attached to an accessory mount and shown in an operating position;

FIG. 3 is a cross-sectional side view of the equipment box of FIG. 1 taken along cutting plane 3-3 illustrating an accessory mount supporting the fish finder in a storage position;

FIG. 4 is a partial, cutaway side view of the equipment box of FIG. 1 illustrating the range of movement of the fish finder on the accessory mount;

FIG. 5 is a partial, cross-sectional side view of the equipment box of FIG. 1 taken along cutting plane 5-5 illustrating the accessory mount supporting the fish finder in an operating position;

FIG. 6 is a cross-sectional view of the equipment box of FIG. 1 taken along cutting plane 6-6 disclosing a heat channel extending between a heat generating light bulb and the battery;

FIG. 7 is a partial, exploded, cutaway view of the equipment box of FIG. 1;

FIG. 8 is a perspective, exploded view of the equipment box of FIG. 1 illustrating an accessory case connected to the box; and

FIG. 9 is an electrical schematic of the electrical connections associated with the equipment box of FIG. 1 showing the respective battery connections.

### DETAILED DESCRIPTION OF THE PREFERRED EMBODIMENTS

Referring now to FIG. 1, an embodiment 10 of a cold weather equipment box here shown as an ice fishing tackle box includes a generally hollow, rigid housing 12 preferably having a carrying handle 14, a front 16, a back 18, a top portion 20 and a bottom portion 22 interconnected by at least one hinge 24, each portion 20, 22 having an interior surface 26a, 26b respectively, and an exterior surface 28a, 28b respectively. FIG. 1 shows the housing 12 in a closed position wherein the lid 20a of top portion 20 lies flush against the bottom portion 22. Preferably at least one latch 30 is provided such that the top portion 20 can be releasably secured to the bottom portion 22.

The embodiment 10 of the ice fishing tackle box of the present invention further includes a heat generating light source, here shown as bulb or lamp 40, preferably an incandescent light bulb of about 30 watts, secured to the bottom portion 22. The heat generating light source 40 has a transparent front cover 42, a back 44 and is powered by an electric storage battery 32 positioned within the housing 12. Although an incandescent bulb is shown with the embodiment 10, it should be understood that any now known or hereafter developed light source capable of producing sufficient heat energy may be used and is within the scope of the invention. Preferably, the heat generating light source 40 is selectively, electrically connected to the battery through a switch 82 such that the lamp may be turned on or off by manually actuating the switch 82. The light source 40 not only illuminates the area in front of the housing 12 but produces heat energy as an otherwise wasted by-product of lighting, and that heat energy is conveyed to the battery as further described hereafter so as to keep the temperature of battery 32 at a level well above freezing so as to maintain battery output capacity in cold conditions. When a typical incandescent light bulb is illuminated, approximately 90-95% of the power consumed by the light bulb is emitted as heat energy. The ice fishing tackle box 10 of the present invention directs the heat emitted from the back of the heat generating light bulb 40 towards the battery 32 to maintain its temperature. In order to direct the heat, the tackle box 10 includes a heat channel 50 extending between the back 44 of the incandescent light bulb 40 and the battery 32. The preferred heat channel 50 is a tunnel 52 and, more preferably, the tunnel 52 is provided with an outer layer of insulating material 54 to minimize heat loss from the tunnel. The heat channel 50 may be further insulated by providing an insulative gasket 46 that seals the joint between the lamp 40 and the bottom portion 22 of the housing.

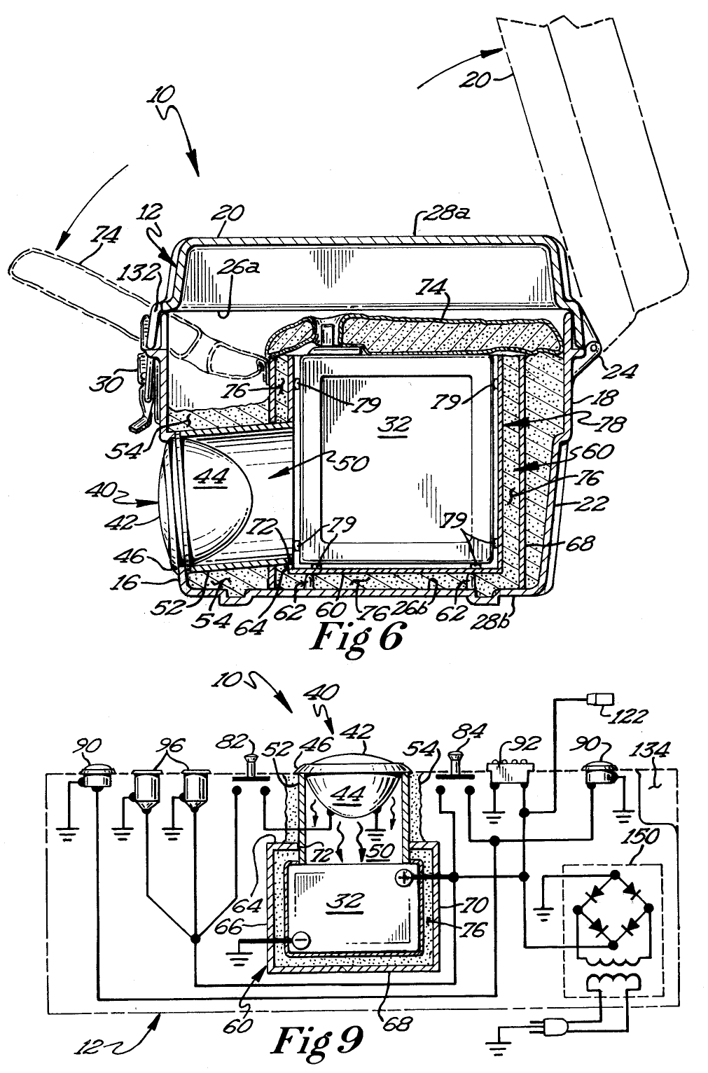

Although a substantial amount of heat from the lamp 40 is transferred to the battery 32, it is preferable to enhance the retention of such heat closely adjacent the battery by providing a battery enclosure 60 which preferably is spaced from but closely surrounds the battery so as to retain the heat energy adjacent the sides and bottom of the battery. The preferred battery enclosure 60 includes a bottom 62, first wall 64, second wall 66, third wall 68, fourth wall 70 and a closely fitting but removable top flap 74. The first wall 64 has an aperture 72 connected with the heat channel 50 so that heat emitted from the back of the heat generating light source 40 flows directly from the channel 50 into the battery enclosure 60 to warm the battery 32. The walls and bottom of the battery enclosure 60 may be formed of an insulating material, such as polystyrene or the like and may include a separate layer of insulation 76, either outside or inside the battery enclosure 60, such as foam polyurethane insulation, polystyrene, fiberglass or the like. In one version of the invention, liquid foam may be sprayed between the inside of the battery enclosure and the battery, but this arrangement can make removal and replacement of the battery more difficult. Therefore, it can be beneficial for the battery enclosure 60 to further include an inner liner 78 that closely abuts the insulation of the enclosure walls and bottom but has a heat circulating space between the liner 76 and the battery 32, as best shown in FIG. 6. This space permits easy insertion or removal of the battery 32 while facilitating heat flow around the battery 32 to enhance heat distribution and utilization. In preferred embodiments, the liner 78 is spaced from the battery 32 by approximately one fourth to one three quarters inch, preferably one half inch, to encourage such heat circulation about the battery. Even more preferably, the liner 78 includes interior ribs, spacers 79 or the like to restrict battery movement while still allowing heat to freely circulate.

As best shown in FIGS. 6 and 9, in the preferred embodiment, the battery enclosure 60 further includes a top flap 74 that is positioned above the battery 32 and fits closely against the walls of the enclosure to provide an insulative layer cover. The bottom 62 of battery enclosure 60 is preferably provided with a plurality of upright rigid support stands 63 that space the battery 32 slightly upward of the bottom 62 such that a separate layer 76 of insulation may be injected or sprayed underneath the battery 32 while preserving a heat circulating space beneath the battery to allow heat from the heat channel 50 to access the bottom of the battery. The stands 63 additionally help to enhance the effectiveness of insulation 76 by preventing the weight of the battery 32 from compressing the insulation layer 76.

Additionally, the embodiment 10 of the ice fishing tackle box may include a secondary light source, preferably a more energy efficient light source such as a pair of LED's 90 which may be electrically connected in parallel with one another and in series through a switch 84 to battery 32 for selective actuation. If desired, a battery charge level indicator or meter 92 may also be connected in series with the battery so as to obtain a readout of the condition of the battery.

In the preferred embodiment 10, a pair of DC sockets 96 are shown mounted to the front of the tackle box, and these may be standard 12 volt accessory sockets capable of powering mobile phone chargers, radios and the like. If desired, one or more of the sockets may be connected through a manually actuated switch, and such alternative is within the scope of the invention.

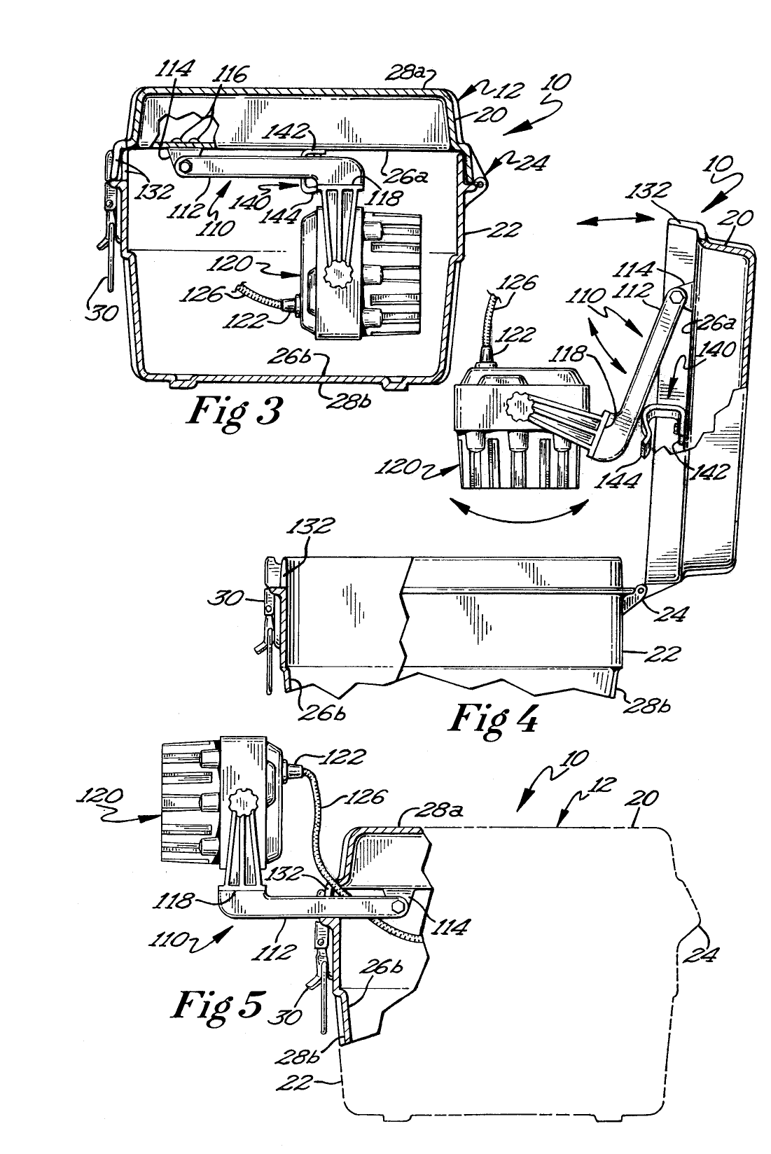

As best shown in FIGS. 3 and 9 a power cord 126 is electrically connected in series with the battery and extends to power plug 122 which may be selectively connected to the power input socket of fish finder 120 when the user wishes to energize the fish finder 120.

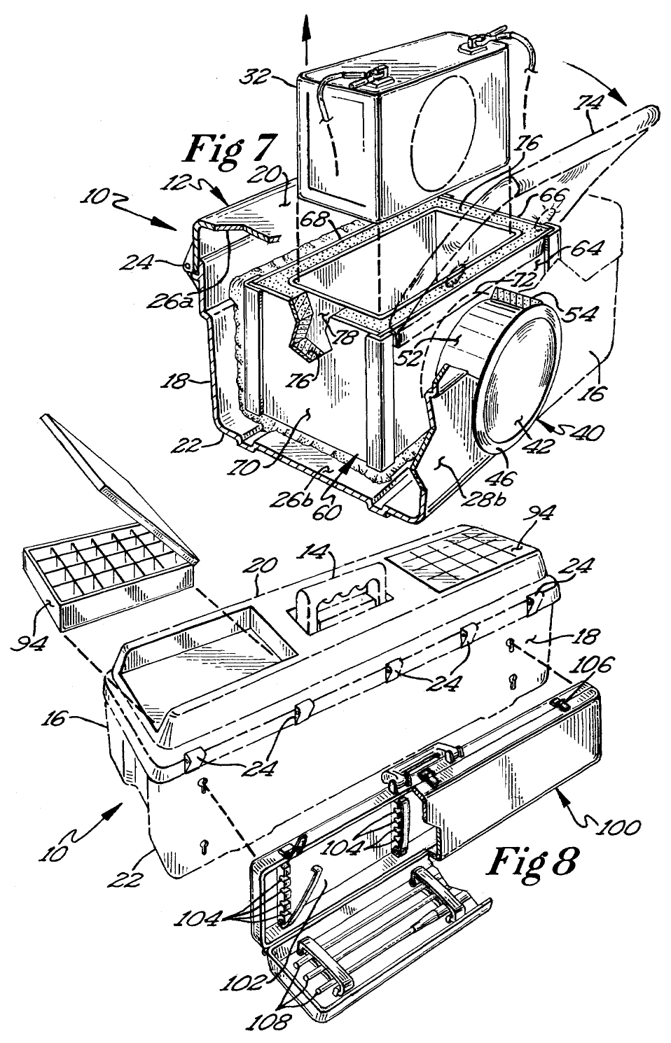

As best shown in FIG. 8, the preferred embodiment 10 further includes at least one compartmentalized tray 94. Each compartmentalized tray 94 may be used for separating and organizing tools, hardware, lures, hooks and the like so that they are easy to find and will not get intertwined with other objects in the tray. Preferably, each compartmentalized tray 94 is located in the top portion 22 so that the tray's contents are accessible without having to expose the battery 32 to the elements.

Because the ice fishing tackle box 10 of the present invention is contemplated as being capable of providing power for multiple electronic devices, a battery 32 having a capacity between about 10 to about 40 ampere hours is preferred, more preferably between about 27 to about 33 ampere hours in capacity. Batteries of that type are often of substantial size and can be moderately heavy. Therefore, it is further contemplated that the embodiment 10 may be provided with housings having various sized battery enclosures for different battery sizes so that the consumer can evaluate and choose a preferred weight versus battery power capacity for his specific power requirements and climate conditions. It is also preferred that the battery 32 be centrally positioned within the bottom portion 22 of the housing and that the handle 14 be centrally located on the top portion 20 above the battery so that the housing 12 is substantially balanced and easy to carry. When the battery 32 is centrally positioned within the bottom portion 22, the battery 32 is also better insulated from the outside temperatures as the space between the battery 32 and the housing 12 will be more optimized.

Referring now to FIG. 8, the preferred ice fishing tackle box 10 may include an accessory case 100 attached to the back 18 that may be used to store and transport various fishing equipment such as fishing rod sections 108. The preferred accessory case 100 includes an interior 102 having a plurality of retaining members 104 arranged and configured such that the fishing rod sections 108 may be snapped into the retaining members 104 so that the sections 108 may be stored within the accessory case 100. The accessory case 100 may be securely closed with a latch 106. Additionally, the preferred accessory case 100 is arranged and configured such that the housing 12 may be opened without the case 100 interfering with the rearward swinging movement of the hinged top portion 20.

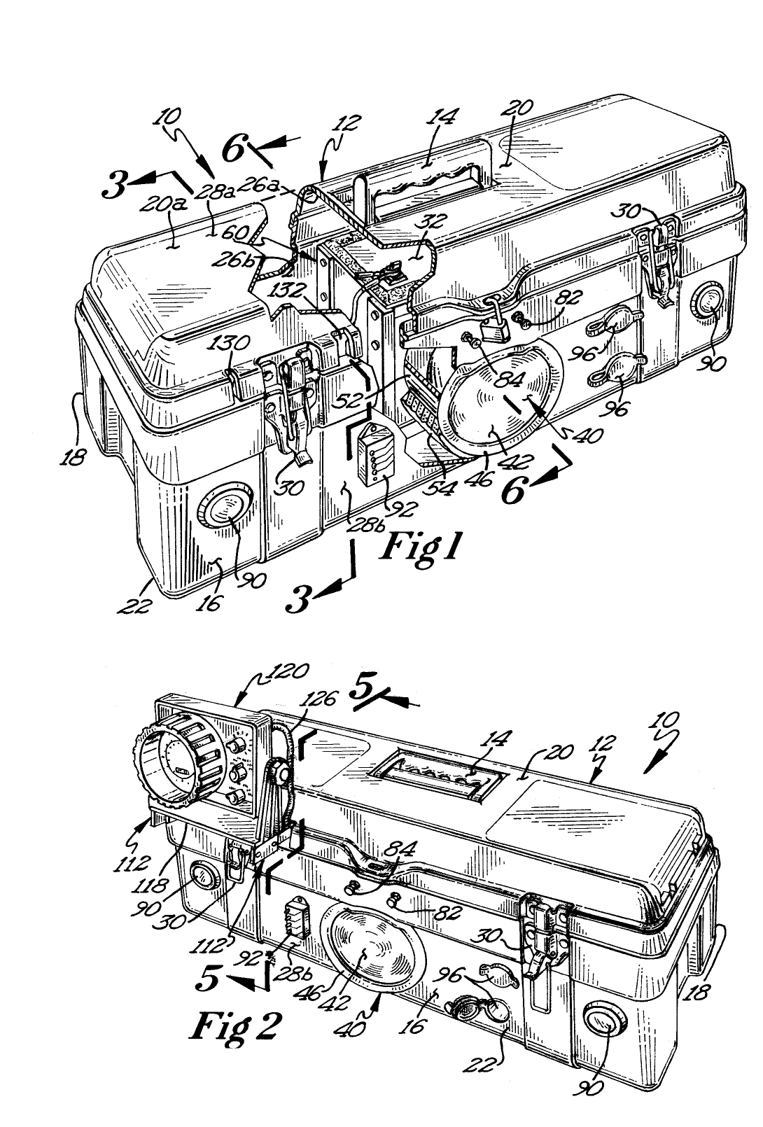

Referring now to FIGS. 2-5, the embodiment 10 of the ice fishing tackle box preferably includes an accessory mount 110 that may be used to support a fish finder 120 or alternative fishing device. The preferred accessory mount 110 includes at least one arm 112 rotatably mounted to the inner surface 26a of the top portion 20 of the housing with a bracket 114 and at least one fastener 116. In the shown embodiment, the preferred accessory mount 110 includes a pair of arms 112 each having a bracket 114 attached to the inner surface 26a of the top portion 20 with a fastener 116. The arms 112 each have a mounting surface 118 on which the fish finder 120 is secured. To house the standard transducer (not shown) associated with a conventional fish finder, the ice fishing tackle box 10 includes a pocket 134 positioned in the bottom portion 22. To accommodate the arms 112 and a power cord 126 for connecting the fish finder 120 to the battery 32, slots 130 and 132 are formed in the top portion 20 of the housing and are arranged and configured such that the arms 112 and cord 126 may extend out of the housing 12 when the housing 12 is closed. It is advantageous to use the fishing device 120 while the housing 12 is closed since the ice fishing tackle box 10 is then easier to transport and the battery 32 can remain protected from the elements.

The preferred ice fishing tackle box 10 includes a restraining element 140 connected to the interior surface 26a of the top portion 20 that may be used to secure the accessory mount 110 in a generally fixed storage position, wherein the top portion 20 may be closed with ease. Without the restraining element 140, the fish finder 120 may swing downwardly, outwardly and strike the inside surface 26b of the bottom portion 22, thereby making the top portion 20 difficult to close and possibly damaging the fish finder 120. The preferred restraining element 140 is a hook having a short first portion 142 interconnected to a longer second portion 144. The first portion 142 is rotatably fastened on the inner surface 26a of the top portion 20 and the second portion 144 may be rotated so that it engages an opening in the fish finder 120 such that when the top portion 20 is lowered, the fish finder 120 does not swing outwardly, and the housing 12 may be closed with ease. A simple rotation of the restraining element 140 can engage and disengage the fish finder 120 for either storing or operation, respectively. FIG. 3 shows the fish finder 120 in a storage position, wherein the accessory mount 110 and the fish finder 120 are secured within the housing 12. The restraining element 140 is engaged with the fish finder 120 such that the arms 112 are generally immovable. FIG. 5 depicts the fish finder 120 in one of many possible operating positions, wherein the arms 112 may be rotated approximately 180 degrees and into the slots 130, 132 so that the fish finder 120 can be used while the housing 12 is closed (see FIG. 1). Further, the battery 32 will stay warmer if the housing 12 remains closed while the fish finder 120 is being used, thereby maintaining battery life, especially, in cold conditions.

Referring now to FIG. 9, the preferred equipment box 10 may include a conventional battery charger 150 operatively electrically connected to the battery 32 so that the battery 32 can be easily and conveniently recharged.

In operation, when a user plans on using the equipment box 10, the box would preferably be kept in a heated room for a period of time with its lid open so that the entire enclosure and the battery will reach room temperature before using the box in the colder outdoors. It is further recommended that the battery be fully charged prior to outdoor use so that the battery is at full power capacity and additionally because the process of charging warms the battery. When the equipment box reaches the ice fishing or other use site, such as the interior of an ice fishing house, the user may actuate the heat generating lamp 40 by closing switch 82. While the lamp 40 illuminates the fishing house interior, the otherwise wasted heat energy from the bulb 40 flows rearwardly along channel 50 and through aperture 72 to further heat the battery enclosure 60 and maintain the working temperature of the pre-warmed battery 32. Warm air reaching the enclosure 60 flows under the battery and around the battery perimeter in the space between battery 32 and the interior walls of the enclosure 60 to maintain the battery at an effective working temperature while fishing. Alternatively, if temperature conditions are more moderate and the performance of battery 32 is not at risk, the user may forego using any of the light sources or may use only the energy efficient light source 90 so as to preserve battery power. The preferred equipment box of the present invention is extremely versatile and can accommodate many conditions and preferences.

Although the preferred embodiment(s) of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A cold weather equipment box comprising:
a housing having a bottom portion and a top portion, each portion having an interior surface and an exterior surface;
a battery enclosure positioned within the housing and including a first layer of insulation;
a battery for providing electrical energy, the battery positioned within the battery enclosure;
a heat generating light source secured to the bottom portion and operatively electrically connected with the battery, the heat generating light source having a front and a back;
a heat channel extending between the back of the light source and the battery enclosure and communicating with the battery; and
wherein the heat produced by the light source when the light source is energized by the battery is guided by the heat channel to enter the battery enclosure so as to warm and maintain the battery capacity.

2. The equipment box of claim 1, further comprising a second layer of insulating material positioned proximate the battery enclosure.

3. The equipment box of claim 2, wherein the insulating material is selected from the group consisting of polyurethane foam, polystyrene and fiberglass.

4. The equipment box of claim 2, wherein the second layer of insulating material is positioned between the battery enclosure and the battery; the equipment box further comprising a liner positioned between the second layer of insulating material and the battery.

5. The equipment box of claim 1, wherein the battery enclosure includes a bottom; wherein the bottom supports the battery spaced upward from the interior surface of the bottom portion of the housing.

6. The equipment box of claim 5, wherein the battery enclosure further includes a second layer of insulating material located below the battery, wherein the bottom of the battery enclosure supports the battery above the second layer of insulating material.

7. The equipment box of claim 1 and further including a layer of insulating material closely surrounding the heat channel.

8. The equipment box of claim 1, wherein the battery is centrally positioned within the bottom portion of the housing.

9. The equipment box of claim 1, further comprising a battery charging apparatus operatively connected to the battery such that the battery may be charged when the apparatus is connected with a source of electrical power.

10. The equipment box of claim 1, wherein the battery enclosure includes a top flap positioned over the battery and closing the battery enclosure.

11. The equipment box of claim 1, wherein the light source is a 30 watt light bulb.

12. The equipment box of claim 1, further comprising a gasket adjacent the front of the light source and the bottom portion.

13. The equipment box of claim 1, further comprising at least one DC socket carried by the housing and operatively electrically connected with the battery.

14. The equipment box of claim 1, wherein the battery has a capacity of between about 10 to about 40 ampere hours.

15. The equipment box of claim 14, wherein the battery has a capacity of between about 27 to about 33 ampere hours.

16. The equipment box of claim 1, further comprising a battery charge level indicator carried by the housing and operatively electrically connected to the battery.

17. The equipment box of claim 1, further comprising a switch selectively electrically connecting the heat generating light source to the battery.

18. The equipment box of claim 1, further comprising a secondary light source secured to the housing and selectively electrically connected to the battery.

19. The equipment box of claim 18, wherein the secondary light source includes at least one LED.

20. The equipment box of claim 1, further comprising an accessory mount secured to the inner surface of the top portion for movement between a storage position within the housing and an operating position wherein at least part of the accessory mount may be positioned outside of the housing when the housing is closed.

21. The equipment box of claim 20, wherein the top portion of the housing includes a slot and wherein the accessory mount includes an arm rotatably secured to the interior surface of the top portion, the arm having a mounting surface wherein the arm is arranged and configured to move within the slot such that the mounting surface may be positioned outside of the housing when the housing is closed.

22. The equipment box of claim 21, wherein the housing includes a second slot and the accessory mount includes a second arm; wherein each arm is arranged and configured to move within the respective slots such that the mounting surface may be positioned outside of the housing when the housing is closed.

23. The equipment box of claim 20, wherein the mounting surface is arranged and configured to support a fish finder.

24. The equipment box of claim 20, wherein:
a fishing device is attached to the accessory mount;
the housing includes a restraining element moveable between an engaged position and a disengaged position;
wherein the arm may move through an arc of about 180 degrees when the restraining element is in disengaged position with respect to the fishing device; and
wherein the accessory mount is generally immovable when the restraining element is in engaged position.

25. The equipment box of claim 24, wherein the restraining element is rotatably fastened to the interior surface of the top portion.

26. The equipment box of claim 24, wherein the restraining element is a hook.

27. The equipment box of claim 1, wherein the housing has a front and a back; and an accessory case positioned on the back of the housing and adjacent the bottom portion of the housing.

28. The ice fishing tackle box of claim 27, wherein the case has an interior and a plurality of retaining members positioned within the interior.

29. The ice fishing tackle box of claim 1, wherein the light source is an incandescent light bulb.

30. A method of maintaining the power capacity of a battery of a cold weather equipment box, the method comprising the steps of:
providing an equipment box including:
a housing having a top portion and a bottom portion;
a battery enclosure positioned within the housing;
a battery positioned within the battery enclosure for producing electrical energy;
a heat generating light source secured to the bottom portion and having a front and a back; and
a heat channel extending between the back of the light source and the battery;
transferring electrical energy from the battery to the light source;
energizing the light source with electrical energy from the battery to produce heat energy when the light source is illuminated; and
directing the heat energy to the battery.

31. The method of claim 30, wherein the light source is an incandescent light bulb.

32. The method of claim 30, wherein the battery has an electrical capacity of about 10 to about 40 ampere hours.

33. The method of claim 30, wherein heat energy emitted from the back of the light source is directed to the battery.

34. The method of claim 33, wherein the heat energy is directed through an insulated heat channel extending between the back of the light source and the battery.

35. The method of claim 30, wherein the electrical energy is transferred to the light source by actuating a switch.
